(19) United States
(12) Patent Application Publication
(10) Pub. No.: US 2026/0116606 A1
(43) Pub. Date: Apr. 30, 2026

(54) BINDING DEVICE

(71) Applicants: Riko Yagi, Kanagawa (JP); Hidehiko Fujiwara, Tokyo (JP); Natsuki Koike, Kanagawa (JP)

(72) Inventors: Riko Yagi, Kanagawa (JP); Hidehiko Fujiwara, Tokyo (JP); Natsuki Koike, Kanagawa (JP)

(73) Assignee: ETRIA CO., LTD., Kanagawa (JP)

(21) Appl. No.: 19/351,939

(22) Filed: Oct. 7, 2025

(30) Foreign Application Priority Data
Oct. 31, 2024 (JP) 2024-192286

(51) Int. Cl. B65B 51/16; B29C 65/20

(52) U.S. Cl. CPC B65B 51/16; B29C 65/20

(57) ABSTRACT

A binding device includes a pair of rotatable gears to crimp a plurality of packaging sheets having a plurality of welded portions and bags while conveying the plurality of packaging sheets, and a pressing member to press, from above, the plurality of welded portions of the plurality of packaging sheets entering an engagement portion of the pair of gears that are rotating.

### CROSS-REFERENCE TO RELATED APPLICATION

This patent application is based on and claims priority pursuant to 35 U.S.C. § 119 (a) to Japanese Patent Application No. 2024-192286, filed on Oct. 31, 2024, in the Japan Patent Office, the entire disclosure of which is hereby incorporated by reference herein.

### BACKGROUND

### Technical Field

The present disclosure relates to a binding device.

### Background Art

Binding devices are provided with a pair of rotatable gears. Such binding devices make a plurality of packaging sheets having welded portions and bags enter an engagement portion of the pair of gears that are rotating, and crimp the packaging sheets while the pair of gears are conveying the packaging sheets.

Such binding devices crimp medicine packages of heat package whose bags are sealed by welding the openings of the bags of plastic film by heat, or crimp the medicine packages that are placed on top of one another. The medicine packages are an example of packaging sheets and are made of dispensing sheets. In such binding devices, ends of the binding margins of medicine packages to be crimp-bound are pushed against a guide portion located at a rear portion of the binding device with reference to the pair of gears, and the of medicine packages are set such that the bags of the medicine packages, which are filled with medicines, are located at a front portion of the binding device with reference to the pair of gears. Then, the binding margins of the medicine packages are crimp-bound by the pair of gears.

### SUMMARY

The present disclosure described herein provides a binding device including a pair of rotatable gears to crimp a plurality of packaging sheets having a plurality of welded portions and bags while conveying the plurality of packaging sheets, and a pressing member to press, from above, the plurality of welded portions of the plurality of packaging sheets entering an engagement portion of the pair of gears that are rotating.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is an external perspective view of a medicine-package binding machine.

FIG. 2 is a diagram illustrating an internal structure of a medicine-package binding machine.

FIG. 3 is a schematic diagram of a binding mechanism.

FIG. 4 is a schematic diagram of a binding mechanism viewed in a side-to-side direction.

FIG. 5 is a magnified view of a pressing mechanism and elements around the pressing mechanism.

FIG. 6 is a schematic top view of a first gear holder and elements around the first gear holder.

FIG. 7 is a schematic top view of a second gear holder and elements around the second gear holder.

FIG. 8 is a schematic diagram of a second gear at a position to apply pressure.

FIG. 9 is a schematic diagram of a second gear at a position to release pressure.

FIG. 10 is a schematic diagram of a drive transmission assembly.

FIG. 11 is a schematic plan view of an operation panel.

FIG. 12 is a diagram illustrating a medicine package sensor.

FIG. 13 is a schematic side view of a pair of side guides, an upper guide, and elements around those guides.

FIG. 14 is a front view of the second gear holder of FIG. 7.

FIG. 15 is a diagram illustrating control blocks of a medicine-package binding machine.

FIG. 16 is a schematic diagram of a bundle of medicine packages that are crimp-bound.

FIG. 17A and FIG. 17B are schematic diagrams of a pressing member and elements around the pressing member.

FIG. 18A and FIG. 18B are schematic diagrams of a pressing member that has a slidable surface layer that slides over a medicine package.

FIG. 19 is a diagram illustrating how a plurality of medicine packages are crimp-bound.

FIG. 20A is a diagram illustrating how a welded end curls up when a pressing member is absent.

FIG. 20B is a diagram illustrating how a pressing member prevents a welded end from curling up.

FIG. 21 is a graph illustrating a comparison between the binding force when a pressing member is absent and the binding force when a pressing member is present.

FIG. 22A and FIG. 22B are schematic diagrams of an example in which a pressing member is extended to a point downstream from an engagement portion in a conveyance direction.

FIG. 23A, FIG. 23B, and FIG. 23C are schematic diagrams of an example in which only a rear portion of a pressing member that does not overlap with a pair of gears is extended to a center line.

FIG. 24A and FIG. 24B are schematic diagrams of an example in which a downstream end of a pressing member in a conveyance direction is placed at a point upstream from an engagement portion in the conveyance direction.

FIG. 25A, FIG. 25B, and FIG. 25C are schematic diagrams of an example in which a roller is used as a pressing member.

FIG. 26A, FIG. 26B, and FIG. 26C are schematic diagrams of an example in which a pressing member is made movable between a pressing position and a retracted position and the pressing member is placed at the pressing position.

FIG. 27A, FIG. 27B, and FIG. 27C are schematic diagrams of an example in which a pressing member is made movable between a pressing position and a retracted position and the pressing member is placed at the retracted position.

FIG. 28A and FIG. 28B are schematic diagrams of an example in which a pressing member includes a pressing portion parallel to a guiding surface and a guide portion that guides a plurality of medicine packages to a pressing portion.

FIG. 29A and FIG. 29B are schematic diagrams of a first modification of the example of FIG. 28A and FIG. 28B.

FIG. 30A, FIG. 30B, and FIG. 30C are schematic diagrams each of which illustrates a configuration of a second modification of the example illustrated in FIG. 28A and FIG. 28B.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Some embodiments of the present disclosure are described below with reference to the drawings. The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. The above-described embodiments are illustrative and do not limit the present disclosure.

Firstly, a configuration or structure of a medicine-package binding machine 1, which is an example of a binding device, is schematically described.

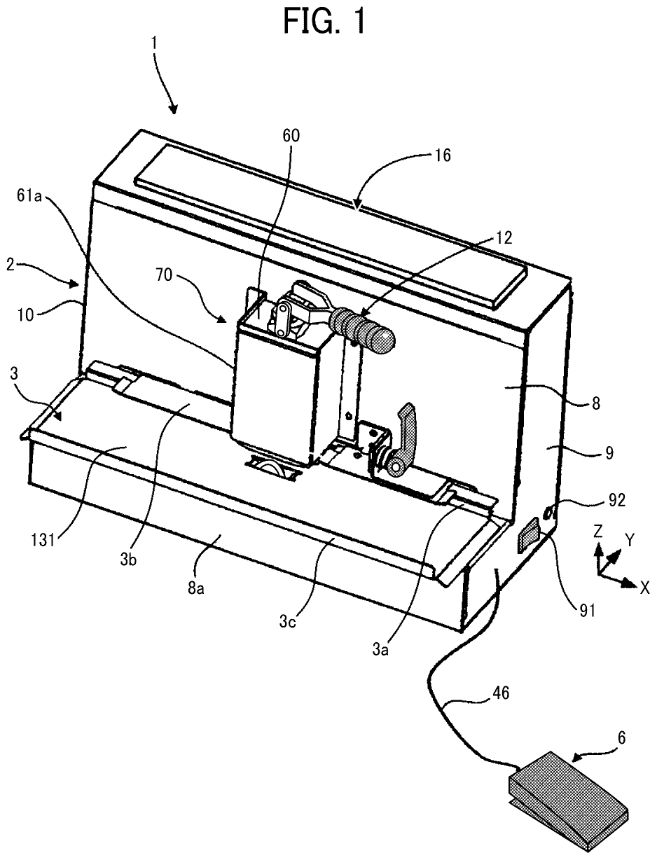

FIG. 1 is an external perspective view of the medicine-package binding machine 1.

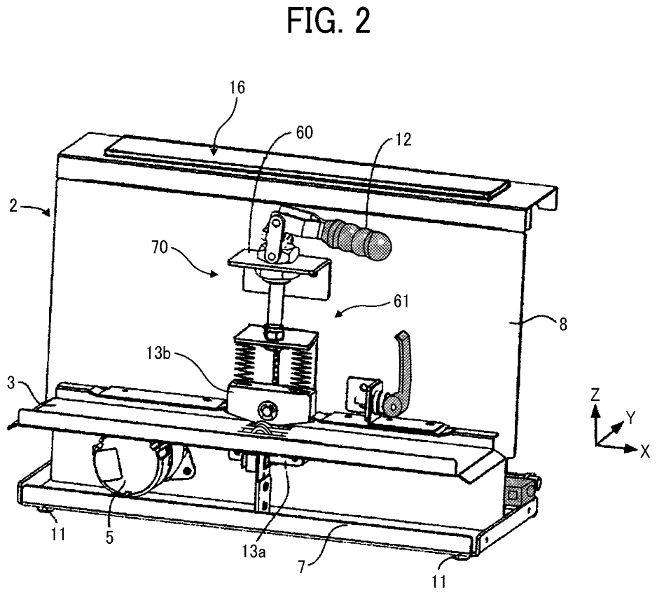

FIG. 2 is a diagram illustrating an internal structure of the medicine-package binding machine 1 of FIG. 1.

In the following description, the lateral direction, the depth direction, and the vertical direction of the medicine-package binding machine 1 are referred to as the X-axis direction, the Y-axis direction, and the Z-axis direction, respectively.

As illustrated in FIG. 1 and FIG. 2, the medicine-package binding machine 1 that is an example of a binding device includes a housing 2, a medicine-package guide 3, a foot switch 6, an operation panel 16, and a binding mechanism 70. As illustrated in FIG. 1 and FIG. 2, the housing 2 of the medicine-package binding machine 1 includes a base panel 7 (see FIG. 2), a side panel 8, a right side-panel cover 9 (see FIG. 1), a left side-panel cover 10 (see FIG. 1), and a front side-panel cover 8a. The housing 2 is provided with a pressure-adjuster cover 61a that covers the pressure adjuster 61 (see FIG. 2) of the binding mechanism 70. The right side-plate cover 9 is provided with a power switch 91 and a power connector 92 connected to external power. The medicine-package guide 3 has a pair of side guides 3a and 3c arranged at both ends in the front-rear direction parallel to the Y-axis direction, and an upper guide 3b that is arranged at a rear portion of the binding device.

The base panel 7 illustrated in FIG. 2 is a base plate formed of sheet metal and shaped like a frame, and lower portions of the side panel 8 are fixed to the base panel 7. The base panel 7 is provided with four legs 11 that support the medicine-package binding machine 1. In FIG. 2, only two of the legs 11 on the front side are visible, and the two legs 11 on the rear side are hidden by the base panel 7 and are not visible. The binding mechanism 70 and the drive motor 5 are mounted on the side panel 8. The drive motor 5 and the base panel 7 are covered with a front side-panel cover 8a as illustrated in FIG. 1.

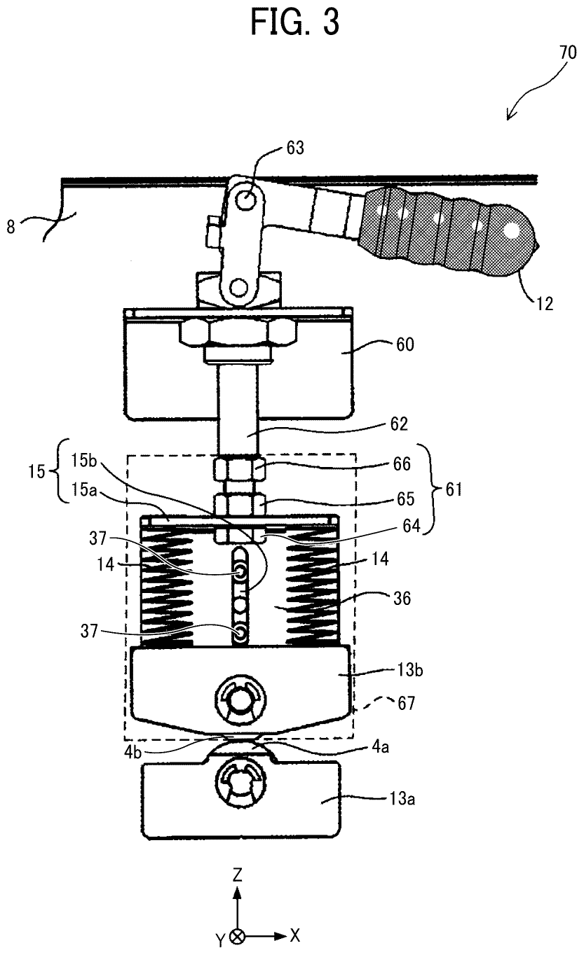

At an upper portion of the side panel 8, a pressure release lever 12 is arranged, having a bracket 60 therebetween. As will be described later, the pressure release lever 12 is operated or manipulated by an operator to apply or release the pressing force of a in second gear 4a (see FIG. 3) to or from a first gear 4b (see FIG. 3).

The bracket 60 is positioned and fixed to the side panel 8, and the pressure release lever 12 and the pressure adjuster 61 that is arranged underneath are installed with reference to the bracket 60. The bracket 60 and the pressure adjuster 61 that moves as operated or manipulated by the pressure release lever 12 are covered with the pressure-adjuster cover 61a.

FIG. 3 is a schematic diagram of the binding mechanism 70.

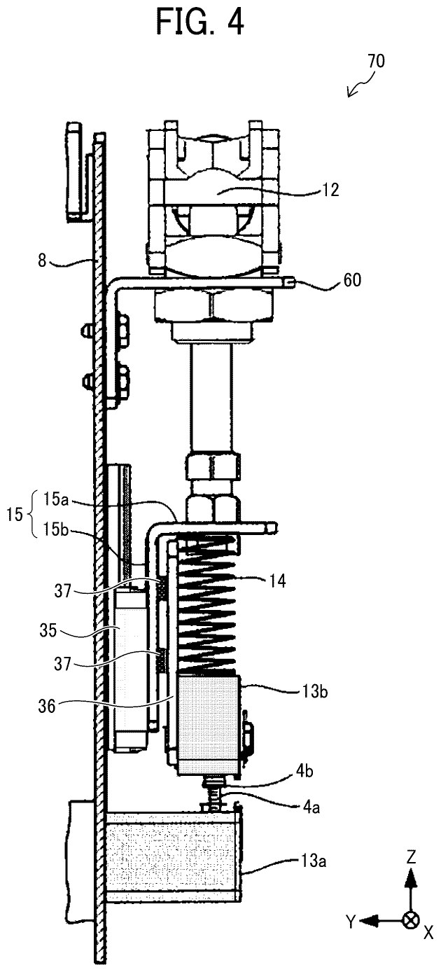

FIG. 4 is a schematic diagram of the binding mechanism 70 viewed in a side-to-side direction parallel to the X-axis direction.

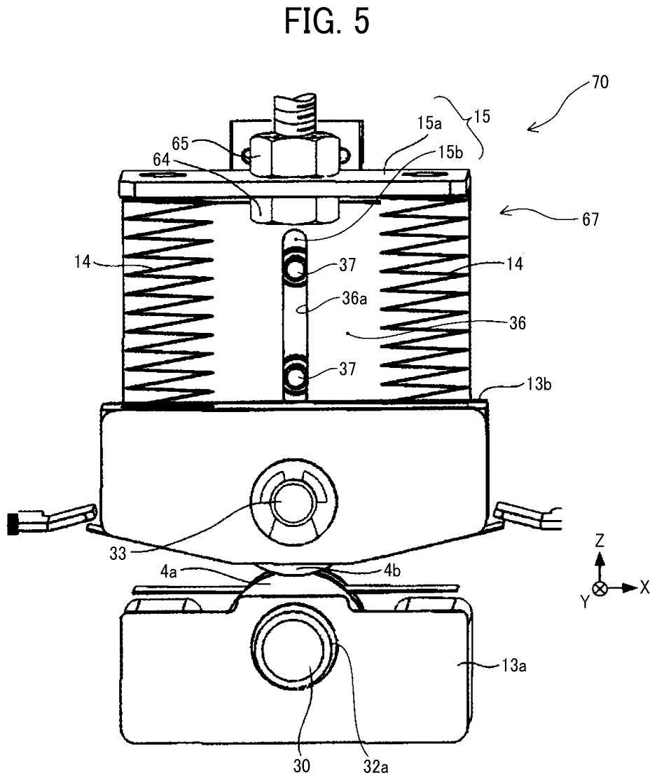

FIG. 5 is a magnified view of the pressing mechanism 67 and elements around the pressing mechanism.

The binding mechanism 70 is provided with a first gear 4a and a second gear 4b that are an example of a pair of crimpers. The binding mechanism 70 is provided with, for example, a pressing mechanism 67, a pressure adjuster 61, and a pressure release lever 12.

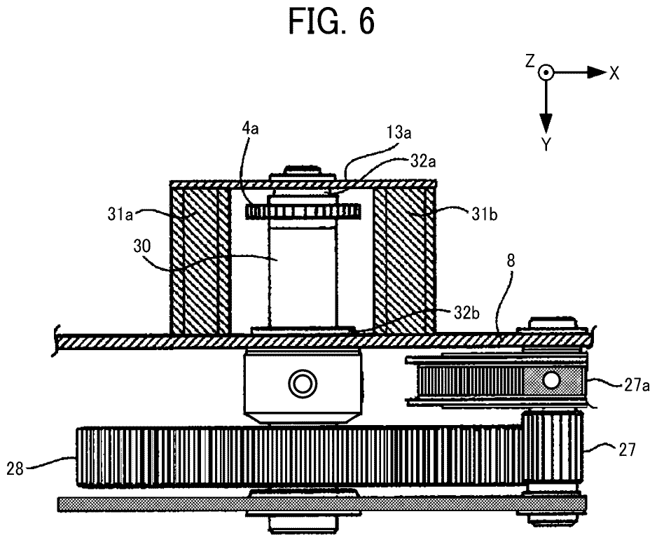

The first gear 4a is attached to the first-gear support shaft 30 so as to rotate integrally with the first-gear support shaft 30. As illustrated in the schematic view of FIG. 6 in which the peripheral area of the first gear 4a is viewed from above, the rear portion of the first-gear support shaft 30 penetrates the side panel 8, and the first-gear support shaft 30 is rotatably supported by the first gear holder 13a and the side panel 8 through a pair of bearing members 32a and 32b. At a rear end of the first-gear support shaft 30, as will be described later in detail, a drive gear 28 of a drive transmission assembly 80 (see FIG. 10) is fitted. As illustrated in FIG. 6, the first gear holder 13a is fixed to a pair of holder fixation members 31a and 31b that are fixed upright to the side panel 8.

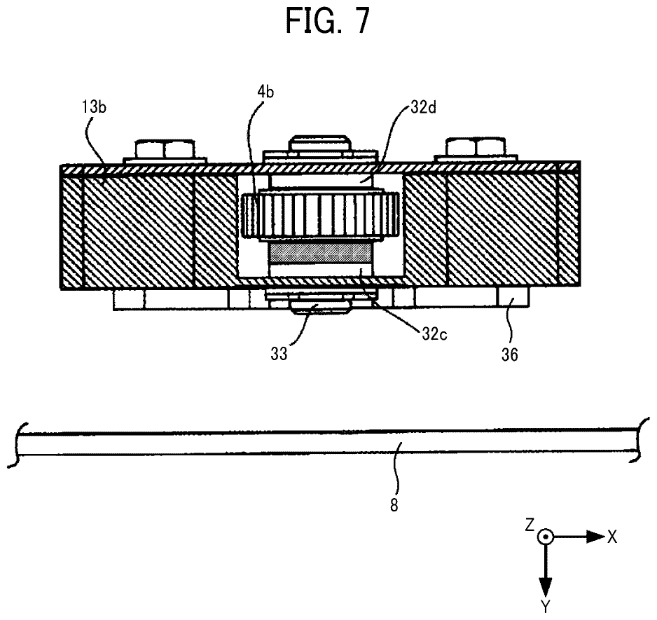

The second gear 4b is attached to the second-gear support shaft 33 so as to rotate integrally with the second-gear support shaft 33. As illustrated in the schematic view of FIG. 7 in which the peripheral area of the second gear 4b is viewed from above, the second-gear support shaft 33 is rotatably supported by the second gear holder 13b through the bearing members 32c and 32d. The second gear holder 13b is fastened to a holder slider 36 by screws. The second-gear support shaft 33 may be fixed to the second gear holder 13b, or the second gear 4b may be rotatably supported by the second-gear support shaft 33.

As illustrated in FIG. 3 to FIG. 5, the pressing mechanism 67 is provided with, for example, a pressure plate 15, a pair of pressing springs 14, and a holder slider 36 to which the second gear holder 13b is fixed. The pressure plate 15 has a top face 15a and a side face 15b, and the side face 15b is supported by a linear guide 35 fixed to the side panel 8, so as to be movable in a predetermined range in the vertical direction parallel to the Z-axis direction.

To the side face 15b of the pressure plate 15, a pair of stepped pins 37 are fixed in the vertical direction parallel to the Z-axis direction. These two stepped pins 37 are inserted into a long hole 36a of the holder slider 36, which extends in the vertical direction parallel to the Z-axis direction, and the holder slider 36 is held by these two stepped pins 37 so as to be movable by a specified distance in the vertical direction parallel to the Z-axis direction, with respect to the pressure plate 15.

The pair of pressing springs 14 is horizontally arranged in the X-axis direction with reference to the second-gear support shaft 33. These pressing springs 14 are fitted in a compressed state between the second gear holder 13b and the top face 15a of the pressure plate 15 with the bottom ends thereof locked to the second gear holder 13b and the top ends thereof locked to the top face 15a of the pressure plate 15. Due to such a configuration, the second gear holder 13b is biased downward toward the first gear 4a by the pair of pressing springs 14, and the second gear 4b held by the second gear holder 13b contacts the first gear 4a with a predetermined pressure.

As illustrated in FIG. 3, the pressure adjuster 61 includes a bolt 64 and a pair of nuts 65 and 66, and the bolt 64 is screwed into the internal threads formed on the inner side of a cylindrical shaft 62. The top face 15a of the pressure plate 15 is held and fixed by the head of the bolt 64 and the nut 65. A nut 66 is used to screw the bolt 64 to the cylindrical shaft 62.

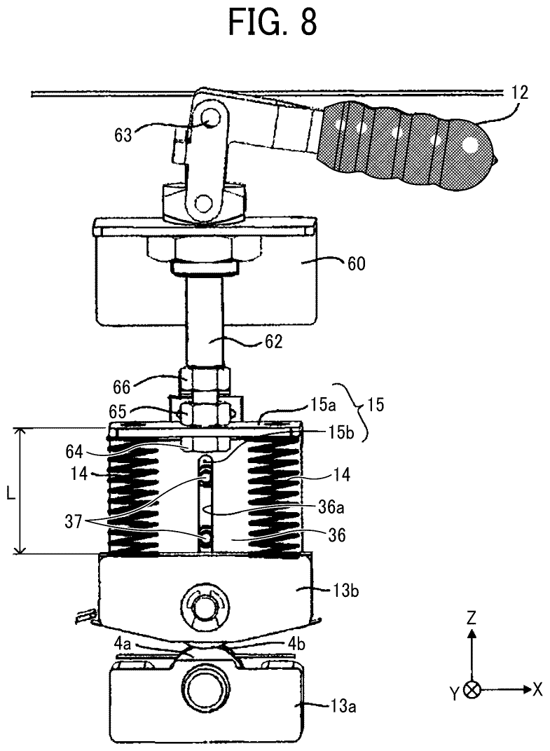

The pressure adjuster 61 adjusts the pressurizing force of the second gear 4b to the first gear 4a by adjusting the vertical position of the bolt 64 screwed into the cylindrical shaft 62. More specifically, the second gear 4b is positioned at a position where the first gear 4a is pressed, and the vertical position of the bolt 64 is adjusted. When the bolt 64 is screwed into the cylindrical shaft 62, the pressure plate 15 moves up relative to the holder slider 36 which is biased downward by the pair of pressing springs 14. Accordingly, a length L illustrated in FIG. 8 between the second gear holder 13b and the top face 15a of the pressure plate 15 increases, and the amount of compression of the pair of pressing springs 14 is reduced. As a result, the pressing force of the pair of pressing springs 14 against the second gear holder 13b decreases, and the pressing force of the second gear 4b against the first gear 4a is reduced.

By contrast, when the bolt 64 is loosened from the cylindrical shaft 62, the pressure plate 15 moves downward relative to the holder slider 36 which is biased downward by the pair of pressing springs 14. Accordingly, the length L illustrated in FIG. 8 between the second gear holder 13b and the top face 15a of the pressure plate 15 decreases, and the amount of compression of the pair of pressing springs 14 increases. As a result, the pressing force of the pair of pressing springs 14 against the second gear holder 13b increases, and the pressing force of the second gear 4b against the first gear 4a increases. When the pressing force of the second gear 4b against the first gear 4a falls within a desired range, the nut 66 is screwed and fixed such that the bolt 64 will not be loosened.

The cylindrical shaft 62 is held by the bracket 60 so as to be movable in the vertical direction, and the top end of the cylindrical shaft 62 is attached to the pressure release lever 12 through a link mechanism. The pressure release lever 12 is rotatably supported by a fulcrum pin 63 provided for the bracket 60.

FIG. 8 is a schematic diagram of the second gear 4b at a position to apply pressure.

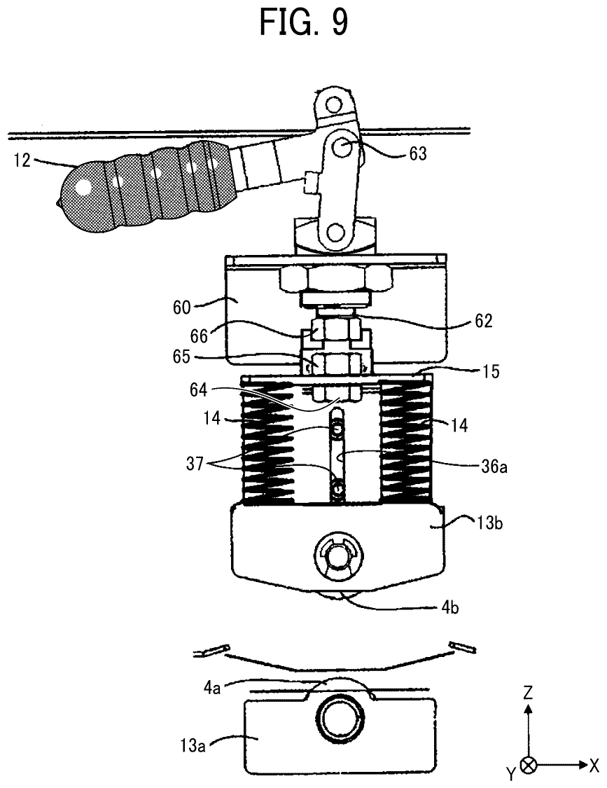

FIG. 9 is a schematic diagram of the second gear 4b at a position to release pressure.

The pressure release lever 12 is supported by the fulcrum pin 63 so as to be rotatable by about 180 degrees, and as illustrated in FIG. 8, the pressure release lever 12 is tilted to the right when the pressing operation is in progress. By contrast, when the pressing force is released, as illustrated in FIG. 9, the pressure release lever 12 is tilted to the left.

As illustrated in FIG. 8, when the pressure release lever 12 is tilted to the right, the second gear 4b contacts the first gear 4a with a predetermined pressing force. When the pressure release lever 12, as illustrated in FIG. 8, is rotated by 180 degrees by an operator, the rotation of the pressure release lever 12 is converted into linear motion in the vertical direction by the link mechanism, and the cylindrical shaft 62 moves upward. When the cylindrical shaft 62 moves upward, the pressure plate 15 that is held between the bolt 64 and the nut 65 of the pressure adjuster 61 moves upward as guided by the linear guide 35.

When the upper stepped pin of the two stepped pins 37 of the pressure plate 15 abuts against the upper end of the 36a of the long hole portion of the holder slider 36, the holder slider 36 rises together with the pressure plate 15. As a result, the second gear holder 13b that is fixed to the holder slider 36 moves upward, and the second gear 4b that is held by the second gear holder 13b moves away from the first gear 4a. Accordingly, the pressure is released. As illustrated in FIG. 9, when the pressure release lever 12 is tilted to the left, the second gear 4b is located at a position to release pressure, which is sufficiently spaced from the first gear 4a.

FIG. 10 is a schematic diagram of the drive transmission assembly 80 that transmits the driving force of the drive motor 5 to the first gear 4a.

The drive transmission assembly 80 is arranged on the rear side of the side panel 8, and includes a timing belt 26 looped over a motor shaft 5a of the drive motor 5 and a pulley 27a, a pulley gear 27 arranged coaxially and integrally with the pulley 27a, and the drive gear 28 that engages with the pulley gear 27. The drive gear 28 is attached to the rear end of the first-gear support shaft 30 so as to rotate integrally with the first-gear support shaft 30 provided with the first gear 4a (see also FIG. 6).

When the drive motor 5 is driven to rotate, the pulleys gear 27 rotate together with the pulley 27a through the timing belt 26, and the drive gear 28 that engages with the pulley gear 27 rotates. As a result, the first gear 4a is driven to rotate through the first-gear support shaft 30. When the drive motor 5 rotates in the clockwise (CW) direction, the drive transmission assembly 80 drives the first gear 4a to rotate in the counterclockwise (CCW) direction at a predetermined speed-reduction ratio.

FIG. 11 is a schematic plan view of the operation panel 16 arranged on a top face of the housing 2 of the medicine-package binding machine 1.

On the operation panel 16, first and second rotation-direction indicators 17c and 17d, a rotation-speed adjustment switch 18, a rotation-speed indicator 18a, a mode switch 19, a plurality of mode indicators 19a, and a feed-amount indicator 20 are arranged. Moreover, feed-amount adjustment switches 21a and 21b, a stop-time indicator 22, a pair of stop-time adjustment switches 23a and 23b, a start-stop switch 24, and a start-stop indicator 24a are arranged on the operation panel 16.

The first and second rotation-direction switches 17a and 17b are used to switch the rotation direction of the first gear 4a to switch the conveyance direction of a medicine package. When the medicine package is to be conveyed from right to left, the first rotation-direction switch 17a on the left is touched or pressed down to turn on the light-emitting diode (LED) of a first rotation-direction indicator 17c on the left. When the medicine package is to be conveyed from left to right, on the contrary, the second rotation-direction switch 17b on the right is touched or pressed down to turn on the LED of a second rotation-direction indicator 17d.

The rotation-speed adjustment switch 18 controls the number of revolutions per minute (rpm) of the drive motor 5 to switch the rotation speed of the first gear 4a among a plurality of stages such as three stages. The rotation-speed adjustment switch 18 serves as a number-of-revolution setting unit or a rotation-speed setting unit to adjust the number of revolutions per minute or the rotation speed of the drive motor 5 in a one-time binding operation. The rotation-speed indicator 18a has three LED lamps that are turned on depending on the three-stage rotation speed, including low speed, medium speed, and high speed, which is switched by an operation made on the rotation-speed adjustment switch 18.

The mode switch 19 is used to switch the binding mode of the medicine-package binding machine 1. Every time the mode switch 19 is touched or pressed down, the binding mode sequentially changes among a single-package mode that may be referred to as a single-package feed mode, an intermittent mode, and a continuous mode. By turning on one of the LEDs of the mode indicators 19a that are arranged on the right of the mode switch 19, which of the binding modes is currently active is indicated.

The feed-amount adjustment switches 21a and 21b are used to adjust the amount of feed of the medicine packages every time the single-package mode (single-package feed mode) or the intermittent mode is run. Each of the feed-amount adjustment switches 21a and 21b is an example of a feeding-distance setting unit used to adjust the amount of feed of a medicine package by the rotation of the first gear 4a and the second gear 4b through the rotation of the drive motor 5. The amount of paper feed that is currently set is displayed on the feed-amount indicator 20. When the feed-amount adjustment switch 21a with a plus sign to switch the amount of paper feed to increase is touched or pressed down, the amount of paper feed increases. When the feed-amount adjustment switch 21b with a minus sign to switch the amount of paper feed to decrease is touched or pressed down, the amount of paper feed decreases.

The stop-time adjustment switches 23a and 23b are used to adjust the stop time between jobs in the intermittent mode. The stop-time adjustment switches 23a and 23b are an example of a stop-time setting device used to set the stop time of the drive motor 5 as desired. The stop time that is currently set is displayed on the stop-time indicator 22. When the stop-time adjustment switch 23a with a sign “+” is touched or pressed down, the length of stop time increases. When the stop-time adjustment switch 23b with a sign “−” is touched or pressed down, the length of stop time decreases.

The start-stop switch 24 is used to start and stop the binding operation of medicine packages in each mode. By operating the start-stop switch 24, the started state and stopped state of the binding operation for medicine packages in each mode can be checked as the LED of the start-stop indicator 24a is turned on or off.

With the foot switch 6 illustrated in FIG. 1, an operation equivalent to an operation that can be done by the above start-stop switch 24 can be performed, and the result of the operation can be checked with the start-stop indicator 24a. For example, all the LEDs are turned off when the operation is stopped, and a green LED is turned on when the operation is in progress. Moreover, a red LED is turned on in the event of an error. Alternatively, in the event of an error, an error code or the like may be displayed using, for example, the feed-amount indicator 20 and the stop-time indicator 22.

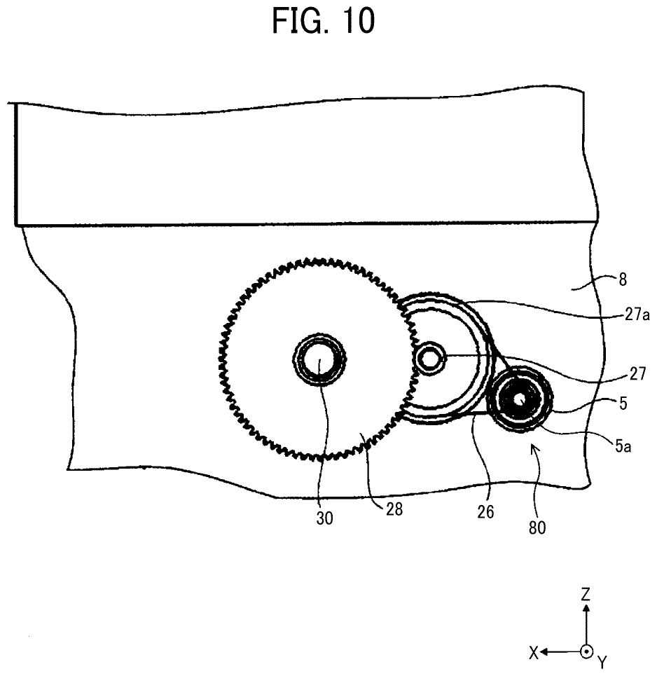

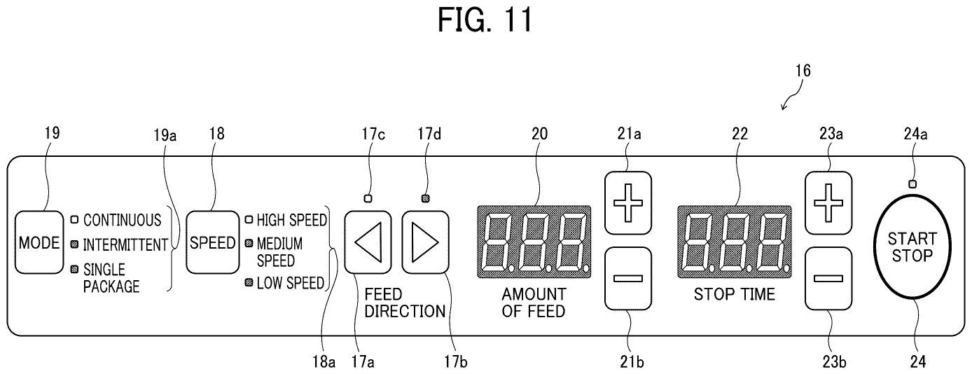

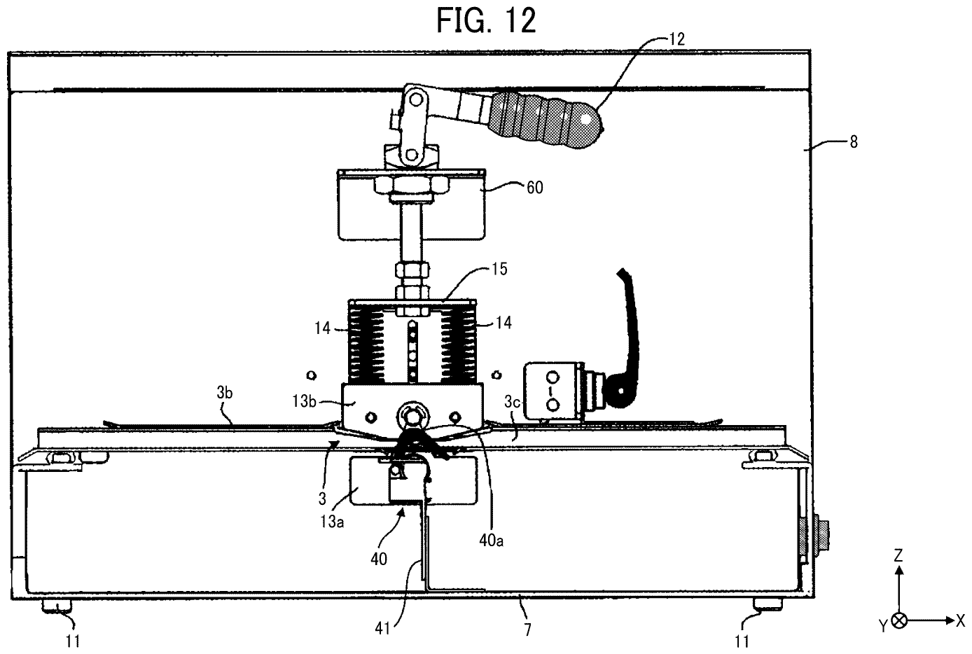

FIG. 12 is a diagram illustrating a medicine package sensor 40 that detects the entry of a medicine package into a binder, i.e., an engagement portion between the first gear 4a and the second gear 4b.

The medicine package sensor 40 includes a detection unit 40a part of which protrudes from a guiding surface of the medicine-package guide 3 and a sensor that detects the movement of the detection unit 40a, and is held by a bracket 41 fixed to the base panel 7 that is also referred to as a bottom plate.

The detection unit 40a moves downward or rotates such that a portion of the detection unit 40a protruding from the guiding surface of the medicine-package guide 3 is retracted from the guiding surface by the medicine package moving to the engagement portion, i.e., a binder, between the first gear 4a and the second gear 4b. As the sensor detects the motion of the detection unit 40a, the entry of a medicine package into the above-described engagement portion is detected.

Both when the bundle of medicine packages moves from left to right and when the bundle of medicine packages moves from right to left, the medicine package sensor 40 can detect a medicine package before the bundle of medicine packages enters a binder, i.e., the engagement portion between the first gear 4a and the second gear 4b. More specifically, both when the bundle of medicine packages moves from left to right and when the bundle of medicine packages moves from right to left, the shape of the detection unit 40a is appropriately formed such that the detection unit 40a can move or rotate as desired and the sensor can detect the movement of the detection unit 40a before the bundle of medicine packages enters the engagement portion.

When the medicine package sensor 40 detects a medicine package, the drive motor 5 starts driving. When the medicine package sensor 40 does not detect a medicine package, the drive motor 5 stops driving. Accordingly, the first gear 4a can be driven to rotate only when a plurality of medicine packages are crimp-bound, and the first gear 4a and the second gear 4b can be prevented from being worn.

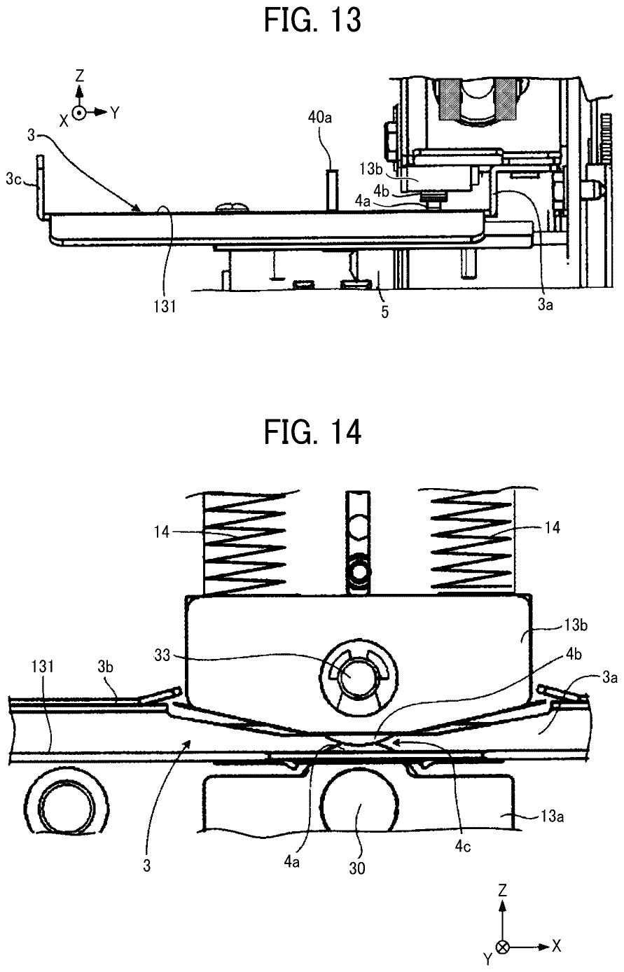

FIG. 13 is a schematic side view of a pair of side guides, an upper guide, and elements around those guides, which are used to bind a plurality of medicine packages.

FIG. 14 is a front view of the second gear holder 13b of FIG. 7.

The medicine-package guide 3 supports a plurality of medicine packages on the top face of the guiding surface 131, and as illustrated in FIG. 13, has the pair of side guides 3a and 3c and the upper guide 3b. The pair of side guides 3a and 3c are arranged at the ends of the medicine-package guide 3 in the front-rear direction. The upper guide 3b may be omitted.

The multiple medicine packages that are stacked on the guiding surface 131, i.e., a table, of the medicine-package guide 3 are guided to an engagement portion 4c between the first gear 4a and the second gear 4b as guided by the medicine-package guide 3. Both ends of the bottom face of the second gear holder 13b in the horizontal direction parallel to the X-axis direction are plane inclined and descend toward the engagement portion 4c.

The first gear 4a and the second gear 4b are pressed at a predetermined level of pressure. When the above-described medicine package sensor 40 detects a medicine package, the drive motor 5 starts driving. Accordingly, the first gear 4a starts rotating, and the second gear 4b rotates together with the first gear 4a. As operated by an operator, the medicine packages that are stacked on top of each other and are inserted into the engagement portion between the first gear 4a and the second gear 4b are crimp-bound by the first gear 4a and the second gear 4b and are conveyed.

When the medicine package sensor 40 no longer detects a medicine package, the drive motor 5 stops rotating, and the first gear 4a and the second gear 4b stops rotating. Moreover, the binding operation stops, and the conveyance of a medicine package stops.

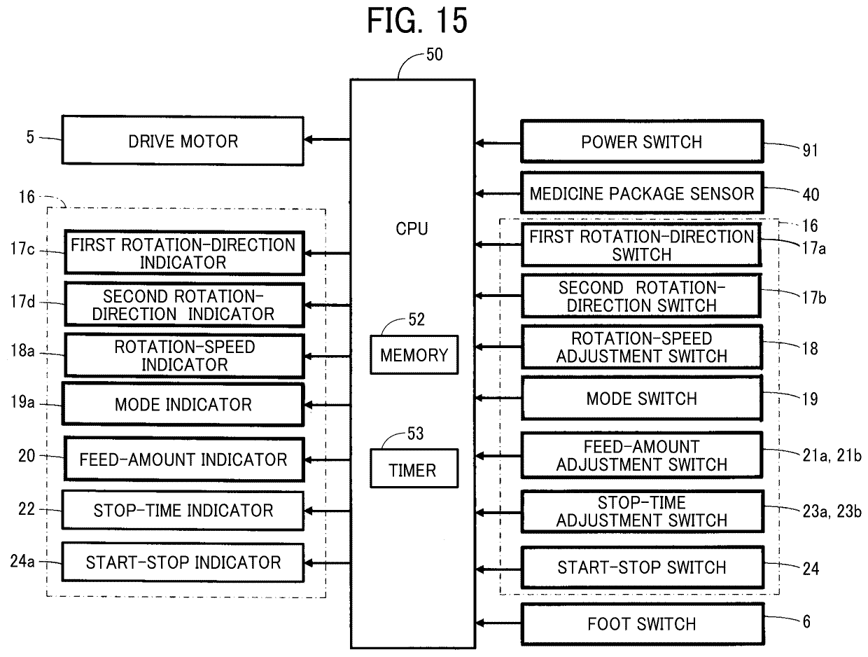

FIG. 15 is a diagram illustrating the control blocks of the medicine-package binding machine 1.

The medicine-package binding machine 1 is provided with a control device 50 that is an example of a controller. The control device 50 is provided with, for example, a central processing unit (CPU), a memory 52, and a timer 53. The CPU may provide notification to an operator or the like at a timing consistent with the program or may instruct the binding device 1 to perform particular operation, based on various kinds of input such as the inputs from various kinds of switches or various kinds of sensors as will be described later in detail.

To the control device 50, signals output from the power switch 91, a first rotation-direction switch 17a, a second rotation-direction switch 17b, a rotation-speed adjustment switch 18, a mode switch 19, the pair of feed-amount adjustment switches 21a and 21b, the medicine package sensor 40, and the foot switch 6 are input. The control device 50 controls, for example, the on and off, rotation direction, and rotation speed of the drive motor 5.

The power switch 91 is supplied with power from, for example, a direct-current (DC) plug of an alternating-current (AC) adapter through a power cable and a power socket installed as a household power supply or a factory power supply. The foot switch 6 is optionally provided for the medicine-package binding machine 1. The foot switch 6 is arranged on the floor as illustrated in FIG. 1, and is coupled to the control device 50 arranged inside the housing 2 through a cord 46.

The memory 52 of the control device 50 includes a random-access memory (RAM) that is referred to as a main memory, and a read-only memory (ROM). The ROM according to the present embodiment stores, for example, a program readable by the above CPU and various kinds of data in advance. Such a program stored in the ROM may be a program used in the flowchart of the controlling processes as will be described later in detail.

The CPU has an input and output (I/O) port, and an operation panel 16 that is an example of a user interface (UI) is electrically connected to that input and output port of the CPU. However, no limitation is intended thereby, and the operation panel 16 may be, for example, a combination of an input device and a display interface such as a combination of a keyboard and a light-emitting diode (LED) display. To the input port of the above CPU, a first rotation-direction switch 17a, a second rotation-direction switch 17b, a rotation-speed adjustment switch 18, a mode switch 19, a pair of feed-amount adjustment switches 21a and 21b, a pair of stop-time adjustment switches 23a and 23b, and a start-stop switch 24 are electrically connected as various kinds of switches arranged on the operation panel 16. To the input port of the above CPU, the medicine package sensor 40 is electrically connected. Moreover, the foot switch 6 that is optional is electrically connected to the input port of the above CPU through the cord 46.

The drive motor 5 is electrically connected to an output port of the CPU through a motor driver. To the output port of the above CPU, the first rotation-direction indicator 17c, the second rotation-direction indicator 17d, the rotation-speed indicator 18a, the mode indicator 19a, the feed-amount indicator 20, the stop-time indicator 22, and the start-stop indicator 24a on the operation panel 16 are electrically connected.

When the input data from the operation panel 16 and various kinds of signals from various types of switches or sensors as above are input to the CPU, the CPU outputs data or signals to various kinds of indicators composed of LEDs or the like as above on the operation panel 16.

The CPU has a function to execute various kinds of control operation. As illustrated in FIG. 15, the CPU of the control device 50 receives the signals sent from the foot switch 6 and various kinds of switches or sensors, and controls the on and off, rotation direction, and rotation speed of the drive motor 5. The data about the operation on the foot switch 6 or various kinds of switches on the operation panel 16 is sent to the control device 50, and the CPU of the control device 50 controls various kinds of operation based on the received data.

The drive motor 5 uses a direct-current (DC) servo motor with which a feeding position can be controlled by pulse, and is controlled by the CPU of the control device 50. By using the drive motor 5, the amount of feed of a medicine package can accurately be controlled. As the drive motor 5, a stepper motor may be used in place of the DC servo motor. However, stepper motors cause significant variations in torque and may cause a loss of synchronization. For this reason, a stepper motor is not suitable for the binding device according to the present embodiment.

The medicine-package bundle that has entered a binder, i.e., the engagement portion 4c between the first gear 4a and the second gear 4b is conveyed by the pair of gears while being pushed in the vertical direction parallel to the Z-axis direction by the teeth of the first gear 4a or the teeth of the second gear 4b. The bundle of medicine packages is clamped between the tooth plane of the first gear 4a and the tooth plane of the second gear 4b, and the bundle of medicine packages is crimp-bound by such clamping force. Immediately after entering the engagement portion 4c, the bundle of medicine packages can move in the forward and backward direction of the binding device, parallel to the Y-axis direction, as the above clamping force is weak for the bundle of medicine packages between the tooth plane of the first gear 4a and the tooth plane of the second gear 4b.

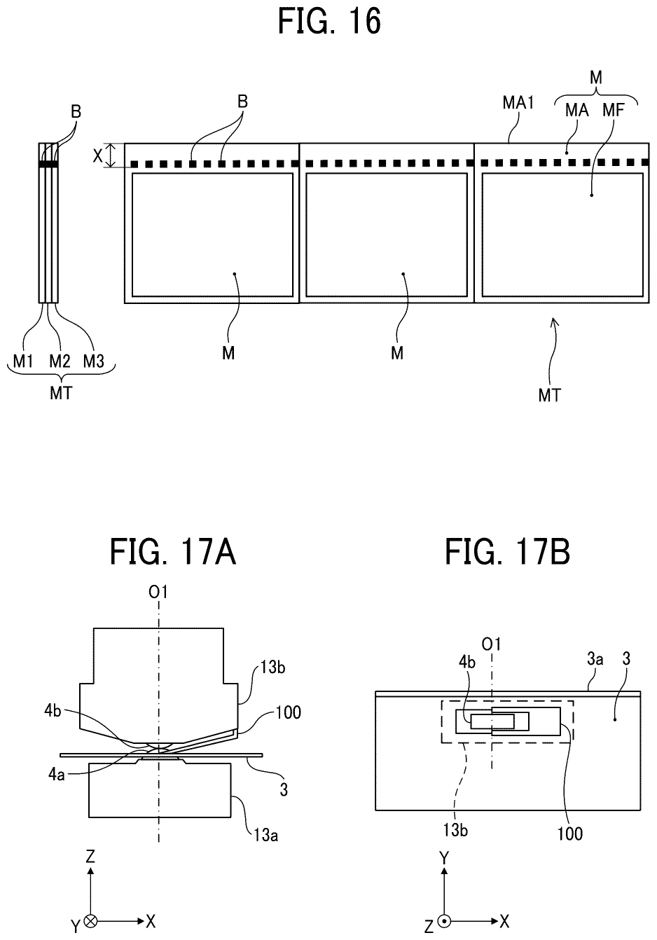

FIG. 16 is a schematic diagram of a medicine-package bundle MT that is crimp-bound.

More specifically, FIG. 16 illustrates a medicine-package bundle MT including three medicine packages M1, M2, and M3. A plurality of medicine packages M are laid in the conveyance direction, and for example, perforations are formed between each pair of the medicine packages M. Typically, each one of the medicine packages M is made of, for example, plastic film or cellophane, and has a bag MF in which a medicine is enclosed and a welded portion MA that is an example of a heat-sealing portion and welds the openings of the bags MF by heat to seal the bags MF. When the material of the medicine package is cellophane, a heat seal layer made of resin is arranged at the opening of the bag MF, and the heat seal layer is welded by heat to seal the bag MF. In the present embodiment, the welded portions MA of the medicine packages M are crimp-bound by the pair of gears 4a and 4b, and the welded portions MA are bound portions and the welded ends MA1 of the medicine packages M are bound ends. In FIG. 16, the welded portions MA are crimp-bound by the pair of gears 4a and 4b at a position distant from the welded end MA1 by distance X.

The bag MF that is filled with the medicines of the medicine package M is expanded by the filled medicine, and a portion of the medicine-package bundle MT near the bag MF is bulky. Accordingly, the welded portions MA of the medicine packages M in the medicine-package bundle MT face each other with a predetermined gap. When the front end of the medicine-package bundle MT in the conveyance direction enters a binder, i.e., the engagement portion 4c under such conditions, the welded portion MA of the uppermost one of the medicine packages of the medicine-package bundle MT is pushed downward by the teeth of the second gear 4b. Accordingly, the welded portion MA moves downward, and the bags MF of upper ones of the medicine packages of the medicine-package bundle MT float up with a point around the teeth of the second gear 4b as a fulcrum. When those bags MF float up, upper ones of the medicine packages push lower ones of the medicine packages toward an area ahead of the binding device. When the medicine-package bundle MT includes two or more medicine packages M, even when upper ones of the medicine packages push lower ones of the medicine packages toward an area ahead of the binding device, lower ones of the medicine packages M do not move to the front side of the binding device as lower ones of the medicine packages M are pushed upward by the teeth of the first gear 4a. However, when the bundle of medicine packages is composed of three or more medicine packages, the welded portions MA of the medicine packages M of the medicine-package bundle MT at midpoint positions do not contact each other, and the pressing force that is applied by the teeth of the pair of gears 4a and 4b is weak even if those welded portions MA contact each other. Accordingly, the medicine packages M at midpoint positions are moved to the front of the binding device by pushing force.

In the present embodiment, the medicine packages M are restricted to move to the front of the binding device by the front side of the side guide 3c. However, the bags MF of the medicine packages M are elastic and has low resilience. For this reason, the bags MF bend and deform due to pushing force, and the welded portions MA of the medicine packages M at midpoint positions move to the front in an unintentional manner. In particular, at the engagement portion, the gaps among the welded portions MA are removed all at once to crimp the welded portions MA together, and thus the bag MF floats up with a great momentum, and the pushing force to push out the medicine package underneath increases, and the bags MF easily bends and deforms. In such cases, the welded ends of the medicine packages at midpoint positions may move away from the side guide 3a on the recess side of the binding device, and the bound ends of the medicine packages M may be crimp-bound without being aligned appropriately. In some cases, the bound ends of medicine packages at midpoint positions may move to the front of the binding device than the positions of the pair of gears, and may not be crimp-bound.

In order to handle such a situation, in the present embodiment, a pressing member is arranged that presses and holds the welded portions MA of a plurality of medicine packages entering an engagement portion from above.

FIG. 17A is a schematic front view of the pressing member 100 and elements around the pressing member 100.

FIG. 17B is schematic plan view of the pressing member 100 and elements around the pressing member 100.

In the present embodiment, as illustrated in FIG. 17A and FIG. 17B, the pressing member 100 that presses and holds a plurality of medicine packages entering an engagement portion from above is attached to an upstream end of the bottom face of the second gear holder 13b in the conveyance direction of the medicine packages M. The pressing member 100 is wider than the tooth widths of the pair of gears 4a and 4b, and extends from the upstream end of the second gear holder 13b to a center line O1 of the pair of gears 4a and 4b.

The pressing member 100 is a plate-shaped member, and a portion that presses the welded portion MA by contacting the welded portion MA is shaped like a leaf spring and is elastically deformable in the vertical direction. The pressing member 100 is attached to the second gear holder 13b with a predetermined gap from the bottom face of the second gear holder 13b, and a portion of the pressing member 100 that presses the welded portion MA is elastically deformable within a predetermined range in the upward direction.

Preferably, the material of the pressing member 100 is a material that can be conveyed without being charged with the surface material of the medicine packages M such as polyethylene terephthalate (PET) and cellophane. The pressing member 100 is preferably made of a material having high slidability with respect to the medicine package, such as fluororesin. By forming the pressing member 100 of a material having high slidability, a plurality of medicine packages can be made to enter an engagement portion smoothly.

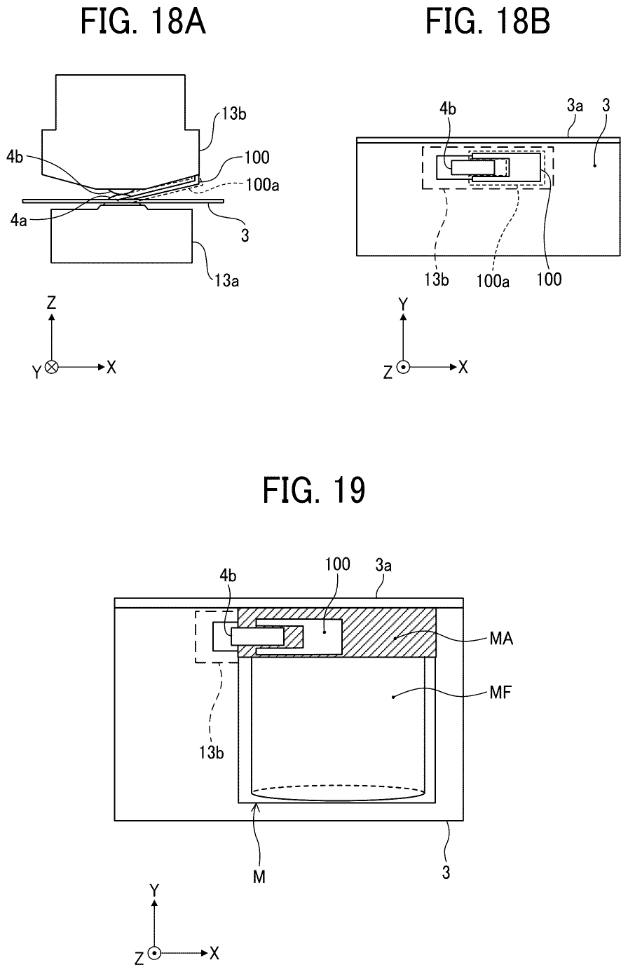

The pressing member 100 may be formed of a sheet metal to increase the pressing force of the pressing member 100 against the medicine packages M. When the pressing member 100 is formed of a sheet metal, as illustrated in FIG. 18A and FIG. 18B, it is desired that a surface layer coated with a slidable material such as fluororesin or fluoroplastic be formed on, at least, a face of the pressing member 100 that slides over the medicine packages M, in order to enable smooth entry of a plurality of medicine packages into an engagement portion.

FIG. 19 is a diagram illustrating how a plurality of medicine packages M are crimp-bound.

In the present embodiment, a label is pasted onto the housing 2 describing how a plurality of medicine packages are to be set or how medicine packages are to be set is described in a user manual such that the welded ends MA1 of the medicine packages M are pushed against the side guide 3a on the recess side. An operator sets a plurality of medicine packages based on what is described on a label or user manual, such that the welded ends MA1 of the medicine packages M are pushed against the side guide 3a on the recess side. Accordingly, the pressing member 100 can press and keep the welded portions MA of the medicine packages M, and the welded portions MA of the medicine packages M are crimp-bound as desired. The welded portion MA is harder than a non-welded portion, and deformation such as waviness or curling at ends does not easily occur. By using the welded portions MA as the binding portion, the bound portions that are flat can be crimp-bound, and the binding force can be increased. Moreover, the medicine packages can be prevented from being crimp-bound with the medicine packages displaced thereamong.

Subsequently, the operator moves the medicine packages M placed at the medicine-package guide 3 from the right side to the left side in FIG. 19. When front end of the medicine packages M in the conveyance direction is inserted between the first gear holder 13a and the second gear holder 13b, the welded portion MA of the uppermost one of the medicine packages M contacts the pressing member 100, and the welded portion MA of the uppermost one of the medicine packages M is pushed down by the pressing member 100. This narrows the gap between the welded portions MA. The medicine packages M enter an engagement portion with the gaps between each pair of the welded portions MA narrowed by the pressing member 100. This prevents the end of the uppermost one of the medicine packages on the bag side from floating up with a great momentum when entering the engagement portion, and the pushing force that pushes the medicine package directly below the uppermost one of the medicine packages toward the bags side by such an uppermost medicine package is lightened.

As the welded portion MA of the uppermost one of the medicine packages M is pressed from above by the pressing member 100, the contact pressure among the bags MF of the medicine packages M can be increased, and the friction force can be increased. Accordingly, the medicine package M directly below the uppermost one of the medicine packages M can be prevented from moving to the front side of the binding device 1 by the pushing force. As a result, the medicine packages M at midpoint positions are prevented from moving forward when the medicine packages M enter the engagement portion, and the medicine packages M can be prevented from being misaligned and crimp-bound.

There are some cases in which, due to the pressing-down operation of the pressing member 100, the ends of the medicine packages M on the other side of the bound ends float up and the medicine packages M at midpoint positions move to the front in an unintentional manner. However, the pressing member 100 has a width, i.e., the length in Y-axis direction in the front-rear direction, longer than the tooth width of the gear, and the medicine packages M at midpoint positions are prevented from moving forward. Unlike the gears, the welded portion MA is gradually pushed downward, and the ends of the medicine packages M on the bags side float up slowly. Accordingly, the momentum for the medicine packages M at midpoint positions to move to the front is reduced. Accordingly, the bending and deformation of the bags MF due to the pressing operation of the pressing member 100 can be prevented, and the welded ends MA1 of the medicine packages M at midpoint positions can be prevented from moving forward.

The medicine packages are manually inserted into the engagement portion by an operator. Due to such a configuration, even when the medicine packages M at midpoint positions are moved to the front as pressed by the pressing member 100, the medicine packages can be pushed to the rear side before the medicine packages are made to enter the engagement portion, and the welded ends MA1 that are an example of the bound ends can be pushed against the side guide 3a. By so doing, the welded ends MA1 of the medicine packages can be aligned as desired.

The pressing member 100 also presses an area around the welded end MA1 of the medicine package. Due to such a configuration, after the welded ends MA1 are pushed against the side guide 3a, the pressing member prevents the welded ends MA1 from floating up as pushed by an operator, and the welded ends MA1 of the medicine packages can be aligned as desired.

For example, waviness or curling at the welded ends MA1 occurs, and there are some cases in which the welded portion MA is not flat. In the present embodiment, the pressing member 100 may press the welded portions MA. Due to such a configuration, when the welded portion MA is not flat, the welded portion MA can be leveled off and flattened. Due to such a configuration, the welded portions MA can be flattened out and made to enter an engagement portion, and for example, a reduction in binding force and a displacement among medicine packages can be prevented. Further, in the present embodiment, a plurality of medicine packages can be pressed and held by the pressing member 100 and be made to enter an engagement portion. Due to such a configuration, when the medicine packages are made to enter the engagement portion, the chances that some of the medicine packages M are displaced and enter the engagement portion can be reduced.

The pressing member 100 is shaped like a leaf spring, and a portion of the pressing member 100 that contacts the welded portion MA is made elastically deformable in the vertical direction. Due to such a configuration, the front end of the welded portion MA of the uppermost one of the medicine packages M in the conveyance direction contacts the pressing member 100, and the pressing member 100 elastically deforms upward by pushing the pressing member 100 in the conveyance direction. This allows the medicine packages to move to the engagement portion smoothly. The upward elastic deformation of the pressing member 100 generates a restoring force. Accordingly, the welded portions MA of the medicine packages M can be pressed down as desired, and the welded portion MA can be leveled off and flattened as desired. The pressing member 100 has a width, i.e., the length in Y-axis direction in the front-rear direction, longer than the tooth width of the gear, to push a wide area of the welded portion MA. Accordingly, the welded portion MA can be flattened as desired.

In the present embodiment, the pressing member 100 presses the welded portions MA of the medicine packages M. Such a configuration is adopted because, when the pressing member 100 presses down the bags MF of the medicine packages M, there are some cases in which the welded portions MA of the medicine packages M cannot be pressed as desired due to the expansion of the bags MF and the welded portion MA cannot be flattened out as desired. In other words, if the bags MF are pushed downward, there is a high possibility that the amount of floating up of the ends of the medicine packages M on the other side of the bound ends increases and the medicine packages M at midpoint positions move to the front in an unintentional manner. As the pressing member 100 presses only the welded portions MA of the medicine packages M, the welded portions MA, which are an example of bound portions, can be pressed as desired and can be flattened out as desired. The bags MF can be prevented from floating up, and the medicine packages M at midpoint positions can be prevented from moving to the front in an unintentional manner.

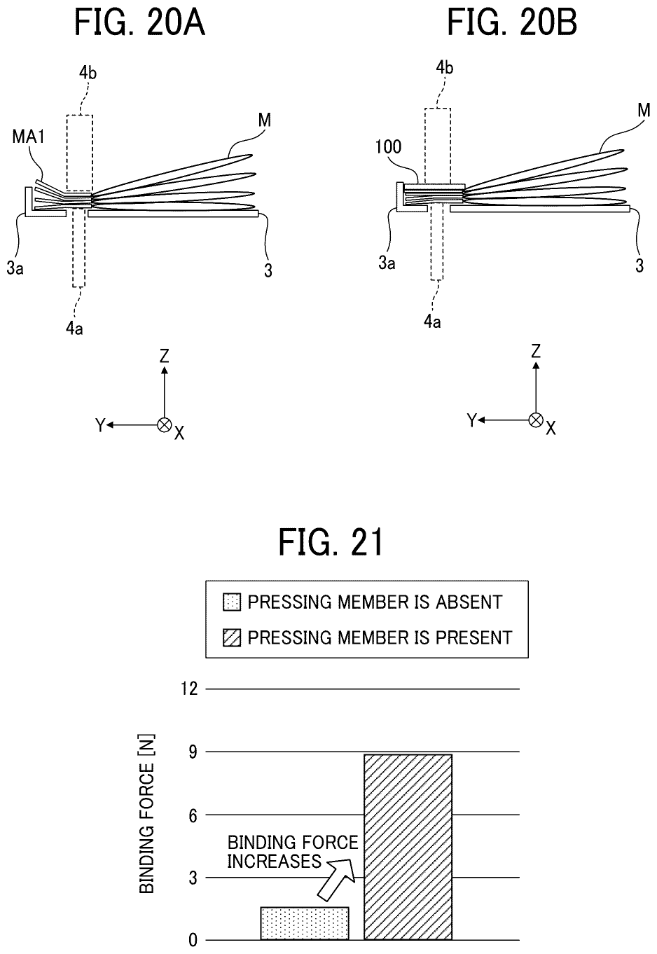

As illustrated in FIG. 20A, when the medicine packages M are crimp-bound by the pair of gears 4a and 4b, the welded ends MA1 that are an example of a bound end may curl up. However, in the present embodiment, as illustrated in FIG. 17A and FIG. 17B, the pressing member 100 extends to the center line O1 of the pair of gears 4a and 4b, and the welded portions MA of the medicine packages M entering an engagement portion are pressed down. Due to such a configuration, as illustrated in FIG. 20B, curling up of the welded ends MA1 can be prevented.

FIG. 21 is a graph illustrating a comparison between the binding force when the pressing member 100 is absent and the binding force when the pressing member 100 is present.

As illustrated in FIG. 21, the binding force can be increased with the provision of the pressing member 100. The welded portions MA to be crimp-bound can be pressed by the pressing member 100, and can be made to enter the engagement portion with the welded portion MA leveled off and flattened. Accordingly, the welded portions MA of the medicine packages M can evenly be pressed in the vertical direction by the teeth of the pair of gears 4a and 4b, and the binding force could be increased compared with cases in which the welded portions MA have, for example, waviness and are uneven and crimp binding is performed without the pressing member 100.

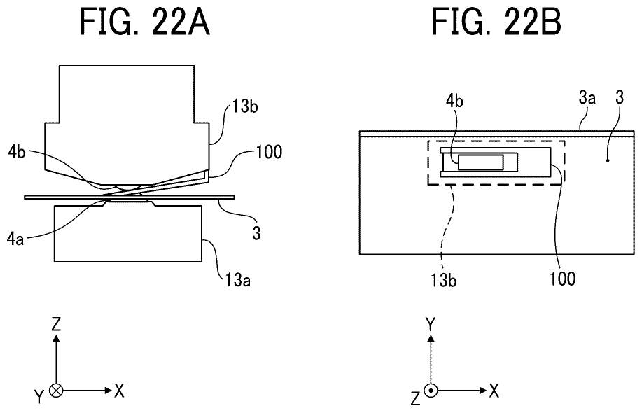

In the above-described embodiments, the pressing member 100 extends to the center line O1. However, no limitation is indicated thereby. As illustrated in FIG. 22A and FIG. 22B, the pressing member 100 may be extended to a point downstream from an engagement portion in the conveyance direction, and the pressing member 100 may press the welded portions MA even after the welded portions MA have passed through the engagement portion. Due to such a configuration, the welded portions MA can be flattened out and crimp-bound with even greater reliability, and the binding force can be increased.

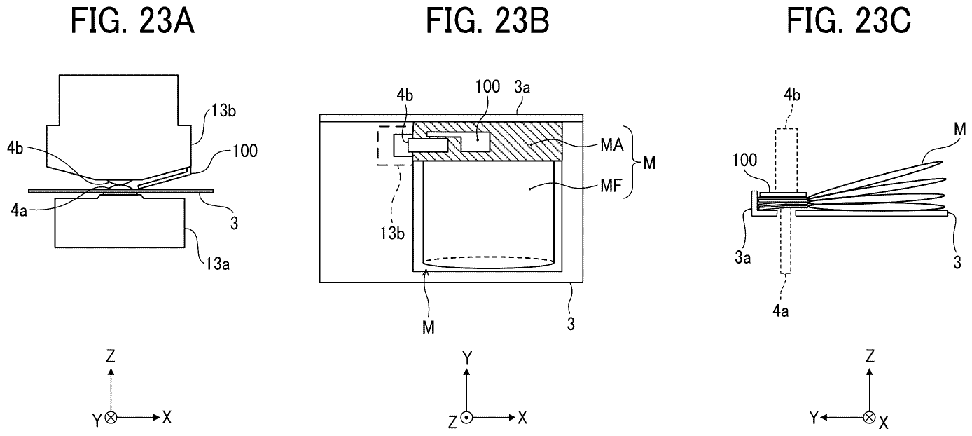

As illustrated in FIG. 23A, FIG. 23B, and FIG. 23C, only a rear portion of the pressing member 100 that does not overlap with the pair of gears 4a and 4b in the forward and backward direction of the binding device, parallel to the Y-axis direction, may be extended to the center line O1, and only the welded ends MA1 of the medicine packages M that have entered an engagement portion may be pressed down. In such a configuration, as illustrated in FIG. 23C, curling up of the welded ends MA1 when crimp binding is performed can be pressed and held by the pressing member 100, and curling up of the welded portions MA at an end can be prevented. Compared with a configuration or structure in which the pressing member 100 is extended to the center line O1 on both the rear side and the front side with reference to the pair of gears 4a and 4b, the conveyance resistance after the medicine packages have entered the engagement portion can be reduced, and conveyance can be performed with high stability by the pair of gears.

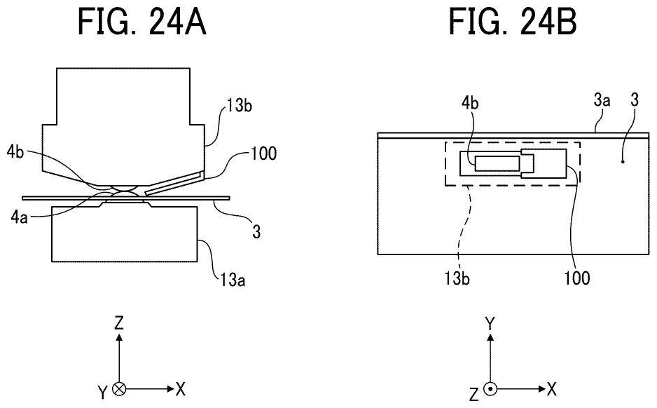

As illustrated in FIG. 24A and FIG. 24B, a downstream end of the pressing member 100 in the conveyance direction may be placed at a point upstream from an engagement portion in the conveyance direction. With such a configuration or structure, the welded portion MA of the uppermost one of the medicine packages M does not easily slide with the pressing member 100 after entering the engagement portion. Accordingly, compared with the configuration or structure described above with reference to FIG. 23A, FIG. 23B, and FIG. 23C, the conveyance resistance after the medicine packages have entered the engagement portion can be reduced, and conveyance can be performed with high stability by the pair of gears. As illustrated in FIG. 24A and FIG. 24B, an area around the welded end MA1 is pressed and held by the pressing member 100 at a point upstream from the engagement portion in the conveyance direction, and the curling up of the welded ends when crimp binding is performed can sufficiently be prevented.

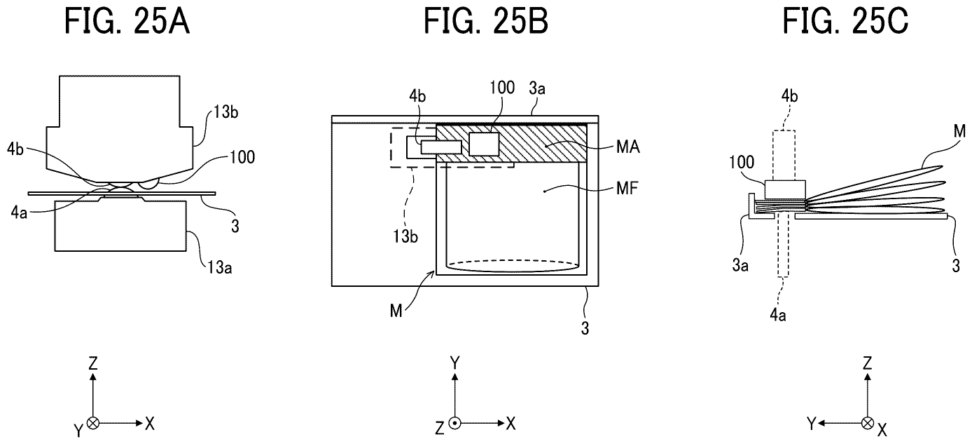

As illustrated in FIG. 25A, FIG. 25B, and FIG. 25C, a roller may be used as the pressing member 100, and the pressing member 100 may be supported by the second gear holder 13b in a rotatable manner. With such a configuration or structure, the pressing member 100 is driven to rotate by the medicine packages M that enters the engagement portion. Accordingly, the conveyance resistance can be reduced, and a plurality of medicine packages can be made to enter an engagement portion smoothly. Even when a roller is used as the pressing member 100, the welded portions MA of the medicine packages M can be pressed as desired, and a plurality of medicine packages can be made to enter an engagement portion smoothly with the gaps between each pair of the welded portions MA narrowed. As illustrated in FIG. 25A, FIG. 25B, and FIG. 25C, by making the width of the roller, i.e., the length in the front-rear direction, wider than the teeth width of the gear, the welded portion MA can be flattened as desired. As a rear end of the roller is located at a rear portion of the binding device with reference to the pair of gears 4a and 4b, as illustrated in FIG. 25C, curling up of the welded ends MA1 when crimp binding is performed can be prevented as desired.

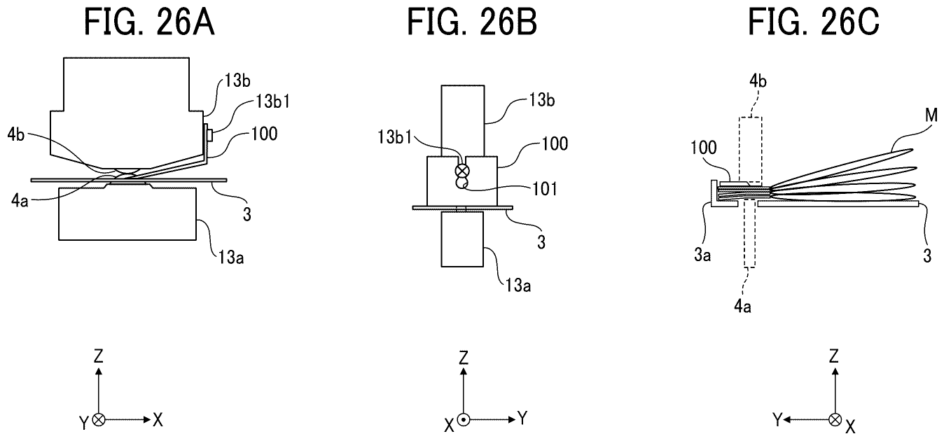

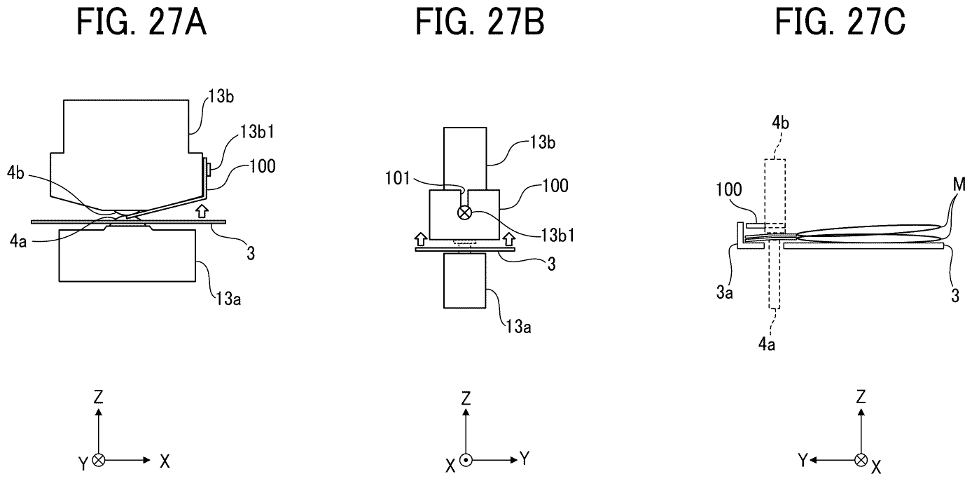

The pressing member 100 may be attached to the second gear holder 13b in a movable manner in the vertical direction, and the pressing member 100 may be made movable between the pressing position illustrated in FIG. 26A, FIG. 26B, and FIG. 26C and the retracted position illustrated in FIG. 27A, FIG. 27B, and FIG. 27C. As illustrated in FIG. 26B or FIG. 27B, a slot 101 that is arranged on the pressing member 100 is fitted to the thread of a fixing screw 13b1 arranged on an upstream side face of the second gear holder 13b in the conveyance direction, to attach the pressing member 100 to the second gear holder 13b in a movable manner in the vertical direction.

By loosening the fixing screw 13b1, the pressing member 100 becomes movable in the vertical direction. When the pressing member 100 is placed at the pressing position illustrated in FIG. 26A, FIG. 26B, and FIG. 26C or the retracted position illustrated in FIG. 27A, FIG. 27B, and FIG. 27C, the fixing screw 13b1 is tightened to fix the pressing member 100 to the second gear holder 13b.

When the medicine packages M at midpoint positions to move to the front and displaced and crimp-bound when three or more medicine packages M enter the engagement portion as described above, or when the welded ends MA1 curl up when crimp binding is performed, as illustrated in FIG. 26C, the pressing member 100 is moved downward and the pressing member 100 is placed at the pressing position. Accordingly, displacement of the medicine packages M at midpoint positions or curling up of the welded ends MA1 can be prevented.

By contrast, as illustrated in FIG. 27C, when the number of the medicine packages M is two and there is no medicine package at midpoint positions or when no end of the welded portions MA curls up when crimp binding is performed, the pressing member 100 is lifted, and the pressing member 100 is placed at a retracted position. Accordingly, the conveyance resistance can be reduced, and a plurality of medicine packages can be made to enter an engagement portion smoothly. When the number of the medicine packages M is two but the welded portions MA are rough and uneven, it is desired that the pressing member 100 be placed at the pressing position to press the welded portions MA by the pressing member 100. By so doing, the welded portions MA can be flattened out and crimp-bound as desired, and crimp binding can be performed with desired binding force.

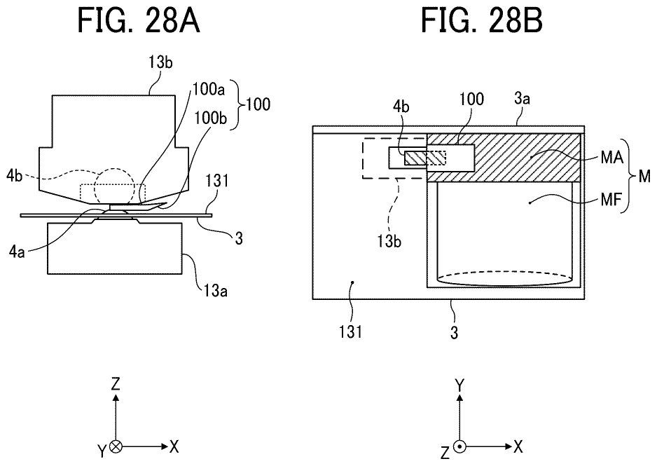

As illustrated in FIG. 28A and FIG. 28B, the pressing member 100 may include a pressing portion 100a parallel to the guiding surface 131 on which the medicine packages M of the medicine-package guide 3 are stacked on top of one another and a guide portion 100b that guides the medicine packages M to the pressing portion 100a. The guide portion 100b protrudes from an upstream end of the pressing portion 100a in the conveyance direction, and is inclined upward an upstream side in the conveyance direction.

By making the pressing portion 100a parallel to the guiding surface 131, the welded portions MA of the medicine packages M entering an engagement portion can be pressed by plane. Due to such a configuration, compared with the pressing member 100 that has a portion shaped like a leaf spring as illustrated in, for example, FIG. 17A and FIG. 17B, the welded portion MA can be leveled off as desired. Accordingly, the welded portion MA can be flattened as desired, and the force of crimp binding can be increased. With the provision of the guide portion 100b, the welded portions MA of the medicine packages M can be smoothly moved between the guiding surface 131 and the pressing portion 100a.

In the pressing member 100 described above with reference to FIG. 28A and FIG. 28B, the contact area with the medicine packages M is greater and the sliding resistance is greater than those of the pressing member 100 that has a portion shaped like a leaf spring as illustrated in, for example, FIG. 17A and FIG. 17B. In order to handle such a situation, in such a configuration or structure, it is desired that the pressing member 100 be made of a material of high slidability for the medicine packages such as fluororesin and fluoroplastic, and it is desired that at least a face of the pressing portion 100a that contacts the welded portion MA of the medicine package be coated with a slidable material such as fluororesin and fluoroplastic.

In FIG. 28A and FIG. 28B, the pressing portion 100a is extended to the center line O1 on both the rear side and the front side in the forward and backward direction of the binding device, parallel to the Y-axis direction, with reference to the pair of gears 4a and 4b. However, no limitation is indicated thereby, and the pressing portion 100a may be extended to the center line O1 on the rear side only. Accordingly, in a similar manner to FIG. 23A, FIG. 23B, and FIG. 23C, curling up of the welded portions MA at an end can be prevented as desired, and the conveyance resistance after the medicine packages have entered the engagement portion can be reduced. Moreover, conveyance can be performed with high stability by the pair of gears.

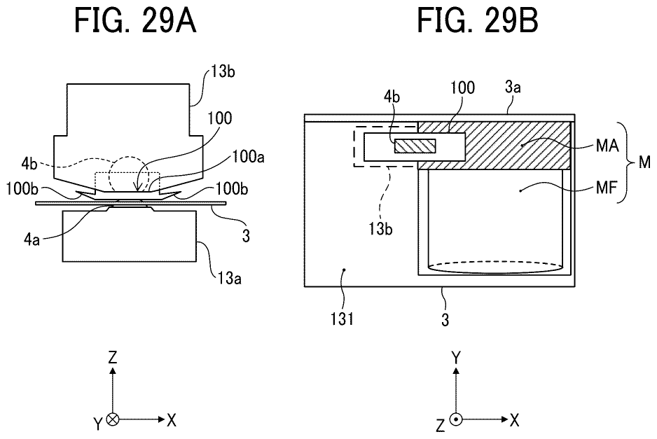

As illustrated in FIG. 29A and FIG. 29B, the pressing portion 100a extends from one side to another side in a conveyance direction with respect to the engagement portion, and a pair of guide portions 100b may be arranged at both ends in the conveyance direction of the pressing portion 100a. In such a configuration, the pressing portion 100a and the guide portion 100b are arranged on one side and the other side, respectively, in the conveyance direction with respect to the engagement portion. With such a configuration or structure, the medicine packages can be pressed and held by the pressing portion 100a from both the right side of the binding device in the +X-axis direction and the left side of the binding device in the −X-axis direction before the medicine packages are made to enter the engagement portion.

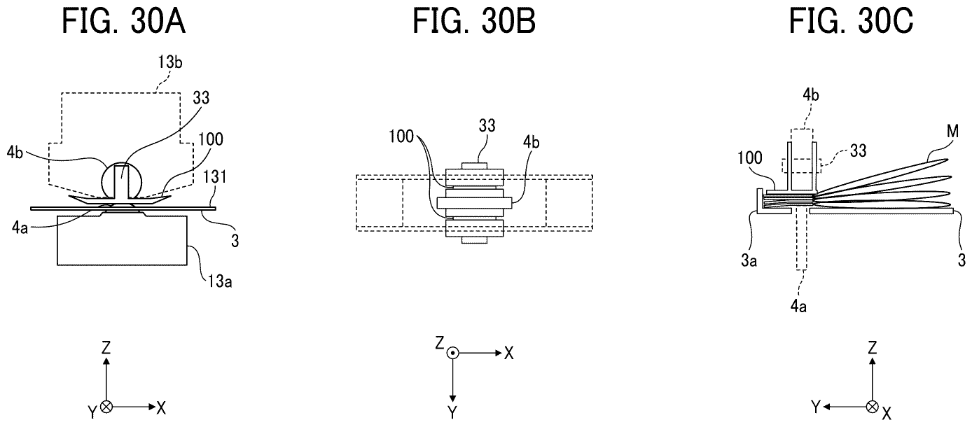

In the configuration illustrated in FIG. 28A, FIG. 28B, FIG. 29A, and FIG. 29B, the pressing member 100 is attached to the bottom face of the second gear holder 13b. However, as illustrated in FIG. 30A to FIG. 30C, it is desired that the pressing member 100 be attached to the second-gear support shaft 33 that supports the second gear 4b. In the configuration illustrated in FIG. 28A, FIG. 28B, FIG. 29A, and FIG. 29B, the pressing member 100 cannot elastically be deformed in the vertical direction, unlike the pressing member 100 that has a portion shaped like a leaf spring as illustrated in, for example, FIG. 17A and FIG. 17B, and it is desired that the relative positions of the pressing member 100 and the second-gear support shaft 33 in the vertical direction be determined with a high degree of precision.

When the pressing member 100 is attached to the second gear holder 13b, the tolerances of the second gear 4b, the second-gear support shaft 33, and the second gear holder 13b are accumulated to the relative positions of the pressing member 100 in the vertical direction. On the other hand, as illustrated in FIG. 30A to FIG. 30C, by attaching the pressing member 100 to the second-gear support shaft 33, the accumulation of tolerances of the second gear holder 13b is eliminated. Accordingly, the precision of the relative positions of the pressing member 100 in the vertical direction can be increased compared with cases where the pressing member 100 is attached to the second gear holder 13b.

As the inclination of the second gear 4b affects, for example, the binding force, the second-gear support shaft 33 is attached to the second gear holder 13b as desired with no inclination in the front-rear direction. Accordingly, by attaching the pressing member 100 to the second-gear support shaft 33, the pressing portion 100a can be made horizontal with a high degree of precision, and the welded portion MA can be flattened out as desired.

The second gear 4b and the pressing member 100 are attached to the second-gear support shaft 33, and the relative position of the second-gear support shaft 33 and the second gear holder 13b are determined and fixed. As the second gear 4b, the second-gear support shaft 33, and the pressing member 100 can collectively be attached to the second gear holder 13b, the assembly can be done efficiently.

In a similar manner to the configuration or structure described above with reference to FIG. 26A, FIG. 26B, FIG. 26C, FIG. 27A, FIG. 27B, and FIG. 27C, the pressing member 100 illustrated in FIG. 28A, FIG. 28B, FIG. 29A, and FIG. 29B may be movable in the vertical direction. Due to such a configuration, the gap between the pressing portion 100a and the guiding surface 131 can be adjusted according to the number or thickness of the medicine packages M, and the welded portions MA can be pressed with an appropriate level of force. This prevents an increment in conveyance resistance due to too strong pressing force. Moreover, the displacement of the medicine packages at midpoint positions toward the bags when entering the engagement portion is prevented, and the welded portion MA can be flattened out as desired. After the adjustment, the pressing member 100 is fixed by, for example, a screw such that the pressing portion 100a will not move upward due to the reaction force from the medicine packages M when the pressing portion 100a presses the medicine packages M. The pressing member 100 illustrated in FIG. 28A, FIG. 28B, FIG. 29A, and FIG. 29B may be movable in the vertical direction, and the pressing member 100 may be pressed downward by a biasing member such as a mechanical spring.

The embodiments described above are given as an example, and advantageous effects are achieved for each of the following modes given below.

### First Aspect

A binding device includes a pair of rotatable gears, and makes a plurality of packaging sheets such as medicine packages M having welded portions and bags enter an engagement portion of the pair of gears that are rotating. The plurality of packaging sheets are crimp-bound while the pair of gears are conveying the plurality of packaging sheets, and the welded portions of the plurality of packaging sheets are crimp-bound. The pressing member also includes a pressing member to press and hold the welded portions MA of the plurality of packaging sheets entering the engagement portion from above. The packaging sheets that have entered the engagement portion of the pair of gears that are rotating are conveyed by the pair of gears while being pushed toward the roots of the teeth of the other one of the gears by the teeth of one of the gears. The packaging sheets are gradually clamped between the tooth planes of one gear and the tooth planes of the other gear, and the packaging sheets are crimp-bound by such clamping force.

Each of the packaging sheets has a bag filled with an object on the other side of the welded portion that is the bound end, and the bags side of the packaging sheets becomes bulky. Accordingly, the welded portions of the packaging sheets to be crimp-bound enter the engagement portion with gaps among the packaging sheets. As the welded portion of the uppermost one of the packaging sheets is pushed downward by the teeth of the upper one of the pair of gears and the welded portion moves downward, the gap between the welded portion of the uppermost one of the packaging sheets and the welded portion of the packaging sheet directly below the uppermost one of the packaging sheets is narrowed. When the welded portion moves downward, the end of the uppermost one of the packaging sheets on the bag side floats up with the bag of the uppermost one of the packaging sheets on the welded portion side as a fulcrum, and the packaging sheet directly below the uppermost one of the packaging sheets toward the bags side is pushed by such an uppermost packaging sheet at such a point that serves as a fulcrum of the floating. As the gaps among the welded portions are removed all at once at the engagement portion to crimp the welded portions together, the end of the uppermost one of the packaging sheets on the bag side floats up with a great momentum. As a result, the pushing force that pushes the packaging sheet directly below the uppermost one of the packaging sheets toward the bags side by such an uppermost packaging sheet is strong, there are some cases in which the packaging sheet immediately below moves toward the bag and the packaging sheets are misaligned and crimp-bound.

In order to handle such a situation, in the first aspect, the welding portions of the packaging sheets are pressed from above by the pressing member and the gaps of the welding portions on the bound side are narrowed in advance, and the packaging sheets enter the engagement portion. Accordingly, the amount of downward movement of the welded portion of the uppermost one of the packaging sheets at the engagement portion is reduced, and the amount of floating of the end of the uppermost one of the packaging sheets on the bag side when entering the engagement portion is small. Moreover, compared with cases in which the gaps of the welding portions on the bound side are not narrowed by the pressing member in advance, the momentum for the end of the uppermost one of the packaging sheets on the bag side to float up when entering the engagement portion is reduced. As a result, the pushing force that pushes the packaging sheet directly below the uppermost one of the packaging sheets toward the bags side by such an uppermost packaging sheet is lightened. Accordingly, the movement of the packaging sheets toward the bags when entering the engagement portion is prevented, and the packaging sheets can be prevented from being misaligned and crimp-bound. Further, such pressing operation of the pressing member prevents the curling up of the welded ends when crimp binding is performed.

Only the areas of the welded portions of the packaging sheets to be crimp-bound are pressed by the pressing member. Due to such a configuration, compared with cases in which the bags that expand due to the object contained in the bags are pressed by a pressing member, the welded portions MA of the medicine packages M can be pressed as desired.

### Second Aspect

In the first aspect, the welded portions of the plurality of packaging sheets such as the medicine packages M are crimp-bound.

Due to such a configuration, as described above in the embodiments of the present disclosure, the welded portions MA of the packaging sheets M, which are harder than a non-welded portion, are flat because deformation such as waviness does not easily occur. By performing crimp binding on the welded portions that are flat, the packaging sheets can evenly be pressed in the vertical direction by the teeth of the pair of gears 4a and 4b, and crimp binding can be performed with relatively high binding force.

### Third Aspect

In the first aspect or the second aspect, the pressing member extends to a rotation center of the pair of gears in a conveyance direction of the plurality of packaging sheets such as the medicine packages M.

Due to such a configuration, as described above in the embodiments of the present disclosure, the medicine packages can be pressed and held by the pressing member 100 from the time when the medicine packages enter the engagement portion to the time when the medicine packages are crimp-bound by the pair of gears. Accordingly, the curling up of the bound end when crimp binding is performed can be prevented as desired.

### Fourth Aspect

In the third aspect, only a portion of the pressing member to press an area around a welded end of the plurality of packaging sheets such as the medicine packages M extends to the rotation center of the pair of gears.

Due to such a configuration, as described above with reference to FIG. 23A, FIG. 23B, and FIG. 23C, the conveyance resistance of the medicine package can be reduced, and the curling up of the bound end when crimp binding is performed can be prevented as desired.

### Fifth Aspect

In any one of the first to fourth aspects, the pressing member can move between a pressing position where the welded portions of the plurality of packaging sheets such as the medicine packages M are pressed and a retracted position where the pressing member is retracted from the pressing position.

Due to such a configuration, as described above with reference to FIG. 26A, FIG. 26B, FIG. 26C, FIG. 27A, FIG. 27B, and FIG. 27C, when an error such as a displacement in the medicine packages M when the medicine packages M enter the engagement portion does not occur even if the pressing by the pressing member is absent, the pressing member 100 can be placed at a retracted position to crimp binding is performed. Accordingly, the conveyance resistance when the pressing member is unnecessary can be reduced, and a plurality of medicine packages can be made to enter an engagement portion smoothly.

### Sixth Aspect

In any one of the first to fifth aspects, the pressing member includes a pressing portion parallel to a table such as the guiding surface on which the plurality of packaging sheets are placed and a guide portion such as the guide portion 100b to guide the welded portion to between the pressing portion and the table.

Due to such a configuration, as described above with reference to FIG. 28A to FIG. 30C, the welded portions MA of packaging sheets such as the medicine packages M entering an engagement portion can be pressed by plane. Due to such a configuration, compared with the pressing member 100 that has a portion shaped like a leaf spring as illustrated in, for example, FIG. 17A and FIG. 17B, the welded portion MA can be leveled off as desired. Accordingly, the welded portion MA can be flattened as desired, and the force of crimp binding can be increased. With the provision of the guide portion 100b, the welded portions MA of packaging sheets can be smoothly moved between the guiding surface 131 and the pressing portion 100a.

### Seventh Aspect

In the sixth aspect, a conveyance direction of the plurality of packaging sheets, by the pair of gears, is switchable, and the pressing member has the pressing portion on one side in the conveyance direction and the guide portion such as the guide portion 100b on another side in the conveyance direction, with reference to a position of the engagement portion.

Due to such a configuration, as described above with reference to FIG. 29A and FIG. 29B, in both cases of conveying the packaging sheets from said one side to the other side in the conveyance direction and conveying the packaging sheets from the other side to said one side in the conveyance direction, the welded portions MA can be pressed by the pressing portion 100a as desired before the packaging sheets are made to enter the engagement portion.

### Eighth Aspect

In any one of the first to seventh aspects, the pressing member 100 is attached to a support shaft such as the second-gear support shaft 33 that supports a gear such as the second gear 4b.

Due to such a configuration, as described above with reference to FIG. 30A to FIG. 30C, compared with cases in which the pressing member 100 is attached to a gear holder such as the second gear holder 13b that holds a support shaft such as the second-gear support shaft 33, the precision of the relative positions of the pressing member 100 in the vertical direction can be increased. Moreover, the pressing portion 100a of the pressing member 100 can be made horizontal with a high degree of precision, and the welded portion MA can be flattened out as desired.

### Ninth Aspect

In any one of the first to fifth aspects, the pressing member 100 has a portion that elastically deform in a vertical direction to press the welded portion MA.

Due to such a configuration, as described above with reference to, for example, FIG. 17A and FIG. 17B, when the front end of the welded portion of the uppermost one of the packaging sheets such as the medicine packages in the conveyance direction, which are made to enter the engagement portion, contacts the pressing portion of the pressing member 100, a pressing portion elastically deforms in an upward direction. This allows the packaging sheets to move to the engagement portion smoothly. The upward elastic deformation of the pressing member 100 generates a restoring force. Accordingly, the welded portions MA of the medicine packages M can be pressed down as desired, and the welded portion MA can be leveled off and flattened as desired.

### Tenth Aspect

In any one of the first to ninth aspects, a portion of the pressing member that contacts at least the welded portion made of a slider.

Due to such a configuration, as described above in the embodiments of the present disclosure, a plurality of packaging sheets such as the medicine packages M can be made to enter an engagement portion smoothly.

### Eleventh Aspect

In any one of the first to ninth aspects, a face of the pressing member that contacts at least the welded portion is coated with a slidable material.

Due to such a configuration, as described above in the embodiments of the present disclosure, a plurality of packaging sheets such as the medicine packages M can be made to enter an engagement portion smoothly.

### Twelfth Aspect

In any one of the first to fifth aspects, the pressing member 100 is a roller that is rotatably supported.

Due to such a configuration, as described above with reference to FIG. 25A, FIG. 25B, and FIG. 25C, a plurality of packaging sheets such as the medicine packages M can be made to enter an engagement portion smoothly.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A binding device comprising:
a pair of rotatable gears to crimp a plurality of packaging sheets having a plurality of welded portions and bags while conveying the plurality of packaging sheets; and
a pressing member to press, from above, the plurality of welded portions of the plurality of packaging sheets entering an engagement portion of the pair of gears that are rotating.

2. The binding device according to claim 1,
wherein the plurality of welded portions of the plurality of packaging sheets are crimped.

3. The binding device according to claim 1,
wherein the pressing member extends to a rotation center of the pair of gears in a conveyance direction of the plurality of packaging sheets.

4. The binding device according to claim 3,
wherein a portion of the pressing member to press an area around a welded end of the plurality of packaging sheets extends to the rotation center of the pair of gears.

5. The binding device according to claim 1,
wherein the pressing member moves between a pressing position where the pressing member presses the plurality of welded portions of the plurality of packaging sheets and a retracted position where the pressing member is retracted from the pressing position.

6. The binding device according to claim 1,
wherein the pressing member includes a pressing portion parallel to a table on which the plurality of packaging sheets are placed and a guide portion to guide the plurality of welded portions to between the pressing portion and the table.

7. The binding device according to claim 6,
wherein a conveyance direction of the plurality of packaging sheets, by the pair of gears, is switchable, and
wherein the pressing member has the pressing portion on one side in the conveyance direction and the guide portion on another side in the conveyance direction, with reference to a position of the engagement portion.

8. The binding device according to claim 6,
wherein the pressing member is attached to a support shaft that supports at least one of the pair of gears.

9. The binding device according to claim 1,
wherein the pressing member includes a portion that elastically deforms in a vertical direction to press the plurality of welded portions.

10. The binding device according to claim 1,
wherein the pressing member includes a slider to contact at least one of the plurality of welded portions.

11. The binding device according to claim 1,
wherein the pressing member includes a face coated with a slidable material to contact at least one of the plurality of welded portions.

12. The binding device according to claim 1,
wherein the pressing member is a roller that is rotatably supported.
